(19) United States
(12) Patent Application Publication
(10) Pub. No.: US 2015/0116231 A1
(43) Pub. Date: Apr. 30, 2015

(54) HAPTIC TOUCH MODULE

(71) Applicant: SAMSUNG ELECTRO-MECHANICS CO., LTD., Suwon-Si (KR)

(72) Inventor: Yong Il Kim, Suwon-Si (KR)

(73) Assignee: SAMSUNG ELECTRO-MECHANICS CO., LTD., Suwon-Si (KR)

(21) Appl. No.: 14/331,154

(22) Filed: Jul. 14, 2014

(30) Foreign Application Priority Data
Oct. 29, 2013 (KR) 10-2013-0129451

(51) Int. Cl. G06F 3/01; G06F 3/041

(52) U.S. Cl. CPC G06F 3/016; G06F 3/0412
USPC 345/173

(57) ABSTRACT

Disclosed herein is a haptic touch module including: a window substrate; a display unit facing the window substrate; and a haptic touch sheet formed on one surface of the display unit and configured by integrating a plurality of haptic devices.

### CROSS REFERENCE TO RELATED APPLICATION

This application claims the benefit of Korean Patent Application No. 10-2013-0129451, filed on Oct. 29, 2013, entitled “Haptic Touch Module,” which is hereby incorporated by reference in its entirety into this application.

### BACKGROUND OF THE INVENTION

1. Technical Field

The present invention relates to a haptic touch module.

2. Description of the Related Art

In accordance with the growth of computers using digital technologies, devices assisting computers have also been developed, and personal computers, portable transmitters and other personal information processors execute processing of text and graphics using a variety of input devices such as a keyboard and a mouse.

Consequently, the use of computers is ever-increasing due to rapid transition into an information-oriented society. However, existing keyboard and mouse currently serving as input devices have limits to efficiently operate products. Therefore, required is a device that is simple, less likely to be miss-operated, and easy for everyone to input information.

In addition, techniques for input devices are evolving from a level of realizing general functions into a level considering high reliability, durability, innovation, designing and processing. To this end, a touch sensor has been developed as an input device capable of inputting information such as text and graphics.

Such a touch sensor is mounted on a display surface of a display such as an electronic organizer, a flat panel display device including a liquid crystal display (LCD) device, a plasma display panel (PDP), an electroluminescence (El) element or the like, or a cathode ray tube (CRT), so as for a user to select desired information while viewing the display. In addition, types of touch sensors include a resistive type touch panel, a capacitive type touch panel, an electromagnetic type touch panel, a surface acoustic wave (SAW) type touch panel, and an infrared type touch panel.

These various types of touch sensor modules are employed by electronic products depending on factors such as signal amplification, resolution differences, difficulty of designing and processing, optical properties, electrical properties, mechanical properties, resistance to an environment, input characteristics, durability, and economic efficiency. Currently, the resistive type touch sensor module and the capacitive type touch sensor module are most commonly used.

Recently, various methods have been proposed that enable a user to feel as if she or he touches a key so as to identify the position that she or he has touched. For example, as disclosed in Korean Patent Laid-Open Publication No. 2011-0062504, a haptic device is added to a touch panel. Such a haptic device, however, has a problem in that it has to include a separate vibration plate in order to provide a user with tactile feedback.

### PRIOR ART DOCUMENT

### Patent Document

(Patent Document 1) Korean Patent Laid-Open Publication No. 2011-0062504

### SUMMARY OF THE INVENTION

The present invention has been made in an effort to provide a touch sensor module enabling a user to recognize a touch at the time of touching without requiring a separate vibration plate.

According to a first preferred embodiment of the present invention, there is provided a haptic touch sheet including: an insulating sheet; and a plurality of haptic devices inserted into the insulating sheet integrally.

The plurality of haptic devices may be driven as a vibration type or piezo type.

The vibration type may include: an upper case providing a space for rotation; a rotation shaft vertically formed at the center of the upper case; a rotator inserted into and supported rotatably by the rotation shaft; and a stator disposed below the rotator and in the insulating sheet to be connected to an external power source.

The stator may be stacked on one another in the insulating sheet like inductors.

The insulating sheet may be configured of six layers.

The stator may include: coils inserted in the insulating sheet and stacked on one another; a via hole electrically connecting the coils; a first lead-out via transmitting an electrical signal from the insulating sheet to the coils; and a second lead-out via transmitting an electrical signal from the first lead-out via to the insulating sheet.

The haptic devices may be arranged on the insulating sheet in a diamond pattern.

The piezo type may include: an upper electrode applying voltage when being touched; a lower electrode driven by the voltage from the upper electrode; and an actuator layer formed between the upper and lower electrodes, wherein, in the actuator layer, an electrical field is formed by voltage from the upper electrode and mechanical and vertical deformation occurs.

According to a second preferred embodiment of the present invention, there is provided a haptic touch module including: a window substrate; a display unit facing the window substrate; and a haptic touch sheet formed on one surface of the display unit and configured by integrating a plurality of haptic devices.

The plurality of haptic devices may be employed as a vibration type or piezo type.

The vibration type may include: an upper case providing a space for rotation; a rotation shaft vertically formed at the center of the upper case; a rotator inserted into and supported rotatably by the rotation shaft; and a stator disposed below the rotator and in the haptic touch sheet to be connected to an external power source.

The stator may be stacked on one another in the haptic touch sheet like inductors.

The haptic devices may be arranged on the haptic touch sheet in a diamond pattern.

The haptic touch sheet may be configured of six layers.

The stator may include: coils inserted in the haptic touch sheet and stacked on one another; a via hole electrically connecting the coils; a first lead-out via transmitting an electrical signal from the haptic touch sheet to the coils; and a second lead-out via transmitting an electrical signal from the first lead-out via to the haptic touch sheet.

The first and second lead-out vias may be made of Ag, Ag—Pd, Ni or Cu.

The piezo type may include: an upper electrode applying voltage when being touched; a lower electrode driven by the voltage from the upper electrode; and an actuator layer formed between the upper and lower electrodes, wherein, in the actuator layer, an electrical field is formed by voltage from the upper electrode and mechanical and vertical deformation occurs.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a haptic touch module according to a preferred embodiment of the present invention;

FIG. 2 is a plan view of a haptic touch sheet according to a preferred embodiment of the present invention;

FIGS. 3A and 3B are diagrams showing examples of haptic touch sheets on which haptic devices are arranged;

FIG. 4 is a cross-sectional view of a vibration type haptic device according to a preferred embodiment of the present invention;

FIG. 5 is a diagram showing an example of a stacked stator of FIG. 4;

FIG. 6 is a graph showing a waveform of induced voltage by vibration of a magnet of FIG. 4;

FIG. 7 is a diagram showing a haptic touch sheet of a haptic touch module according to a second preferred embodiment and a partial example of a piezo type haptic device; and

FIG. 8 is a cross-sectional view of a piezo type haptic device of FIG. 7.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

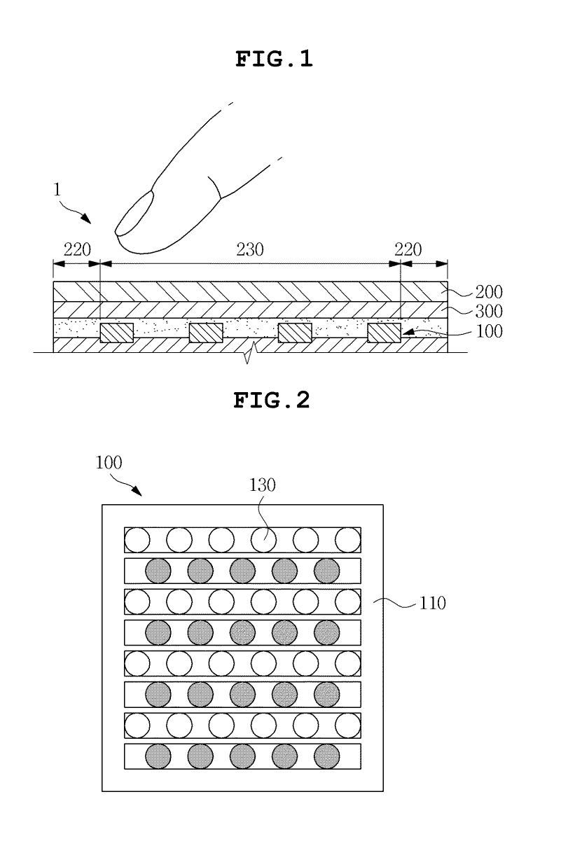

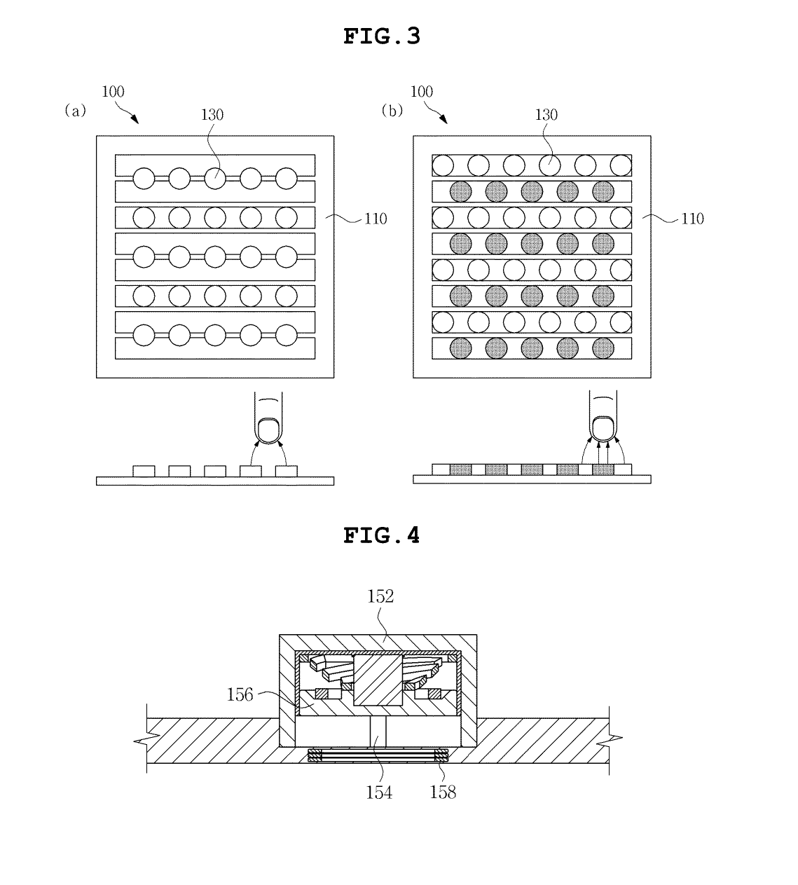

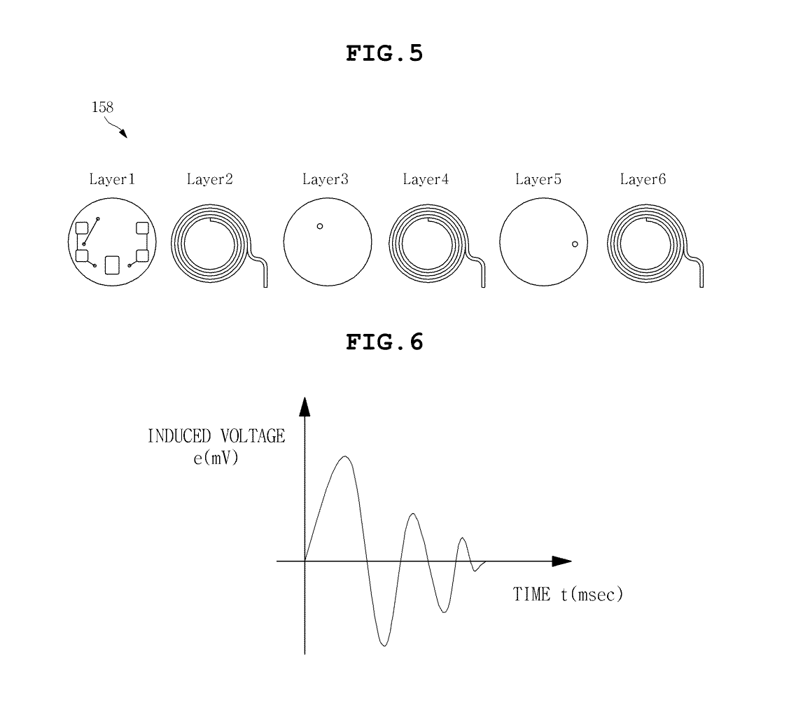

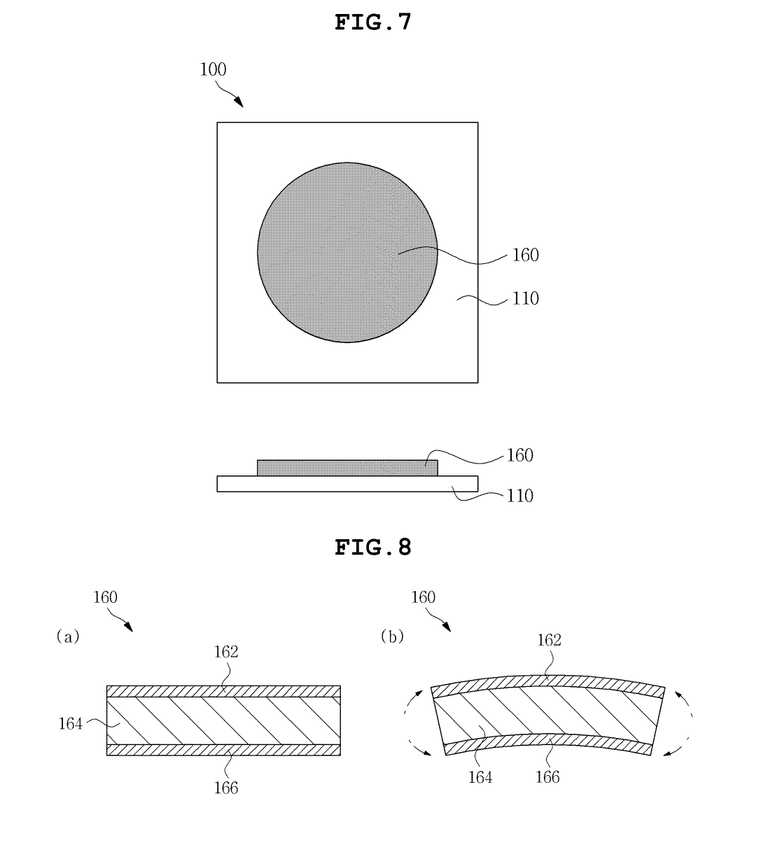

FIG. 1 is a cross-sectional view of a haptic touch module according to a preferred embodiment of the present invention; FIG. 2 is a plan view of a haptic touch sheet according to a preferred embodiment of the present invention; FIGS. 3A and 3B are diagrams showing examples of haptic touch sheets on which haptic devices are arranged; FIG. 4 is a cross-sectional view of a vibration type haptic device according to a preferred embodiment of the present invention; FIG. 5 is a diagram showing an example of a stacked stator of FIG. 4; FIG. 6 is a graph showing a waveform of induced voltage by vibration of a magnet of FIG. 4; FIG. 7 is a diagram showing a haptic touch sheet of a haptic touch module according to a second preferred embodiment and a partial example of a piezo type haptic device; and FIG. 8 is a cross-sectional view of a piezo type haptic device of FIG. 7.

In the specification, the term “touch” not only refers to direct contact on a touch sensing surface but also refers to a proximity touch of a touch sensing surface at a very close distance.

Referring to FIG. 1, a haptic touch module 1 according to a preferred embodiment of the present invention includes: a window substrate 200; a display unit 300 facing the window substrate 200; a haptic touch sheet 100 formed on one surface of the display unit 300 and configured by integrating a plurality of haptic devices 130.

The window substrate 200 is divided into an active region 230 and a non-active region 220. The active region 230 recognizes a touch by input means. The non-active region 220 does not recognize a touch even if it is touched. The non-active region 220 is provided along the edge of the active region 230. The window substrate 200 serves to support the display unit 300 and the haptic touch sheet 100 to be described below. The window substrate 200 should be transparent so that a user may see an image displayed on the display unit 300 therethrough.

The window substrate 200 is located on the outermost side from which a user's touch is input and is made of tempered glass having a sufficient strength such that it serves as a protective layer to protect the display unit 300 and the haptic touch sheet 100. Taking into account the support force and transparency discussed above, the window substrate 200 may be made of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), and biaxially oriented polystyrene (BOPS; containing K resin).

The display unit 300 faces the window substrate 200. The display unit 300 displays an output value that a user has input by touching it. One surface of the display unit 300 is coupled with the window substrate 200 and the other side thereof is coupled with the haptic touch sheet 100. The display unit 300 visually outputs data on a screen and may include, but is not limited to, a cathode ray tube (CRT), a liquid crystal display (LCD), a plasma display panel (PDP), a light emitting diode (LED), and an organic light emitting diode (OLED). The display unit 300 transmits vertical vibration occurring in the haptic touch sheet 100 to the window substrate 200. The display unit 300 also serves to shield the haptic touch sheet 100 so that it is not seen from the outside.

The haptic touch module 1 according to the preferred embodiment of the present invention lets a user recognize that a touch is input when touching the window substrate 200, thereby avoiding touching it repeatedly. Therefore, power consumption of the haptic touch module 1 is reduced and reliability is increased.

Referring to FIGS. 2 and 3, the haptic touch sheet 100 is coupled under the display unit 300. The haptic touch sheet 100 is configured by integrating haptic devices 130 with a flexible insulating sheet 110. The insulating sheet 110 may be made of PI material, for example.

However, the material of the insulating sheet 110 is not limited to the PI material but may include one material known in the field of flexible printed circuit boards. The haptic devices 130 are driven as a vibration type or a piezo type. The haptic devices 130 may be arranged on the insulating sheet 110 in various patterns.

Comparing FIG. 3A with FIG. 3B, the haptic devices 130 are arranged preferably in a diamond pattern. The haptic devices 130 have different intensity of vibration depending on where a touch is input. As shown in FIGS. 3A and 3B, a finger senses different strength of vibration depending on where it is. That is, it can be seen that the haptic devices 130 patterned in a diamond is advantageous in transmitting the intensity of vibration. Furthermore, the haptic devices 130 used in a diamond pattern (in FIG. 3A) are less than those used in a normal pattern (in FIG. 3B). Accordingly, less material is used and thus production cost can be saved.

In some cases, the haptic devices 130 may be arranged in a matrix of N rows and M columns. For example, as shown in FIG. 3A, the haptic devices 130 may be arranged in a matrix of 5 rows and 5 columns.

The haptic devices 130 of vibration type 150 according to a preferred embodiment of the present invention will be described with reference to FIGS. 4 and 5. The vibration type 150 of the haptic devices 130 includes: an upper case 152 providing a space for rotation; a rotation shaft 154 vertically formed at the center of the upper case 152; a rotator 156 inserted into and supported rotatably by the rotation shaft 154; and a stator 158 disposed below the rotator 156 and in the insulating sheet 110 to be connected to an external power source.

The upper case 152 is coupled with the insulating sheet 110 to provide a space. At the center of the inside of the upper case 152, the rotation shaft 154 is formed vertically (see FIG. 4). The rotation shaft 154 supports the upper case 152 and the stator 158 to be described below by applying pressure.

The rotator 156 is rotatably coupled with the rotation shaft 154, serves as a vibrator, and is integrated with a magnet. The magnet of the rotator 156 is supported by a spring guided by a shaft portion so as to reduce pressure. One end of the spring is fixed on the upper case 152 and the other end is in a free state so as to recognize a user's touch point. A touch by a user's finger is recognized in a such manner that a change in magnetic field generated by a change in position of the magnet of the rotator 156 connected to the spring is recognized from a minute voltage generated in coil parts of the stator 158. In this connection, a waveform of induced voltage according to vibration of a magnet by a user is shown in FIG. 6.

Preferably, the rotator 156 is formed as approximately a half disk or a disk so as to easily generate vibration. Preferably, the rotator 156 may have a bearing (not shown) so that it rotates smoothly on the rotation shaft 154.

The stator 158 is inserted in the insulating sheet 110. Above the stator 158, the rotator 156 having a half disk or disk shape is disposed which rotates on the rotation shaft 154.

The stator 158 is configured of layers in insulating sheet 110. The stator 158 is configured of coils in the insulating sheet 110. The coils are wound up around the rotation shaft. The coils are consecutively stacked so as to form a via hole to connect among the layers to obtain an electrical signal. The stator 158 has a first lead-out via receiving a signal from one side of the insulating sheet 110 and a second lead-out via sending a signal to the other side. Preferably, the first and second lead-out vias use material such as Ag, Ag—Pd, Ni or Cu. However, the material of the first and second lead-out vias are not limited thereto.
Preferably, according to a preferred embodiment of the present invention, the stator is configured of six layers like inductors (see FIG. 5). However, the stator 158 is not limited to the six-layer but may be configured of more or less layers depending on the intensity of vibration.

The stator 158 applies an AC voltage signal of N-pole or S pole depending on an electrical signal to drive the rotator 156. That is, if the direction of the current flowing in the coil alternately changed, the direction of the magnetic pole of the coil is also alternately changed accordingly. Then, the rotator 156 is rotated by the magnetic force by N-pole and S-pole to generate vertical vibration with respect to the rotation shaft 154. The control unit (not shown) compares outputs from the plurality of haptic devices 130 to obtain accurate data value. The control unit uses the data value to convert the position of a user's touch into x and y coordinates and transmits it to the display unit 300.

A haptic touch module according to a second preferred embodiment of the present invention will be described with reference to FIGS. 7 and 8. In the following description, the window substrate 200 and the display unit 300 are identical to those in the first preferred embodiment and therefore will not be described. The structure of a haptic touch sheet and piezo type according to the haptic touch module according to the second preferred embodiment of the present invention will be described in detail.

The haptic touch module according to the second preferred embodiment of the present invention includes: a window substrate; a display unit facing the window substrate; and a haptic touch sheet formed on one surface of the display unit and configured by integrating a plurality of haptic devices.

The haptic touch sheet 100 includes an insulating sheet 110 and haptic devices of piezo type 160 coupled with the insulating sheet 110.

The haptic touch sheet 100 is configured by integrating haptic devices of piezo type 160 with a flexible insulating sheet 110 (see FIG. 7). The insulating sheet 110 may be made of PI material, for example. However, the material of the insulating sheet 110 is not limited to the PI material but may include one material known in the field of flexible printed circuit boards. The haptic devices of piezo type 160 may be arranged on the insulating sheet 110 in various patterns.

Comparing FIG. 3A with FIG. 3B, the haptic devices of the piezo type 160 are arranged preferably in a diamond pattern. The haptic devices of piezo type 160 have different intensity of vibration depending on where a touch is input. As shown in FIGS. 3A and 3B, a finger senses different strength of vibration depending on where it is. That is, it can be seen that the haptic devices of piezo type 160 patterned in a diamond is advantageous in transmitting the intensity of vibration. Furthermore, the haptic devices of piezo type 160 used in a diamond pattern (in FIG. 3A) are less than those used in a normal pattern (in FIG. 3B). Accordingly, less material is used and thus production cost can be saved.

In some cases, the haptic devices of piezo type 160 may be arranged in a matrix of N rows and M columns. For example, as shown in FIG. 3A, the haptic devices of piezo type 160 may be arranged in a matrix of 5 rows and 5 columns.

Referring to FIG. 8, the haptic devices of piezo type 160 include an upper electrode 162 to apply voltage when the window substrate 200 is touched, a lower electrode 166 driven by a signal from the upper electrode, and an actuator layer 164 to cause vertical deformation of the upper electrode 162 and the lower electrode 166.

The haptic devices of piezo type 160 recognize a user's touch by generating vibration. In the haptic devices of piezo type 160, when the window substrate 200 is touched, voltage is applied to the upper electrode 162, and the applied voltage drives the lower electrode 166. Preferably, the upper and lower electrodes 162 and 166 are made of a transparent material such an indium tin oxide (ITO). However, the materials of the upper and lower electrodes 162 and 166 are not limited there to. The actuator layer 16 is formed between the upper and lower electrodes 162 and 166.

In the actuator layer 164, magnetic field is generated according to driving signals of the upper and lower electrodes 162 and 166. The actuator layer 164 is vertically deformed by the magnetic field therein so as to cause displacement. The displacement in the vertical deformation of the actuator layer 164 may be adjusted by a physical property value depending on the material, voltage to generate the magnetic field, and the frequency. The actuator layer 164 may be made of an electrostrictive polymer, a dielectric elastomer, an ionic polymer, a piezoelectric polymer, and the like. However, the material of the actuator layer 164 is not limited thereto. Preferably, the thickness of the actuator layer 164 is between 50 μm and 500 μm. The thickness may be adjusted depending on the amount of displacement of the actuator layer 164 depending on the amplitude of voltage and the recognition degree of a user when touching it. The control unit (not shown) compares outputs from the plurality of haptic devices 130 to obtain accurate data value. The control unit uses the data value to convert the position of a user's touch into x and y coordinates and transmits it to the display unit 300.

According to the present invention, by forming haptic devices on a haptic touch sheet, a user may be provided with tactile feedback sensed by her or his finger.

In addition, .by forming haptic devices on a haptic touch sheet, it is possible to emotionally satisfy a user.

Further, by forming haptic devices on a haptic touch sheet, a separate vibration plate is not required to thereby provide a thinner haptic touch module.

Further, by forming haptic devices on a haptic touch sheet, a haptic touch module thinner than existing touch sensor modules can be provided.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A haptic touch sheet, comprising:
an insulating sheet; and
a plurality of haptic devices inserted into the insulating sheet integrally.

2. The haptic touch sheet as set forth in claim 1, wherein the plurality of haptic devices is driven as a vibration type or piezo type.

3. The haptic touch sheet as set forth in claim 2, wherein each of the vibration type haptic devices includes:
an upper case providing a space for rotation;
a rotation shaft vertically formed at the center of the upper case;
a rotator inserted into and supported rotatably by the rotation shaft; and
a stator disposed below the rotator and in the insulating sheet to be connected to an external power source.

4. The haptic touch sheet as set forth in claim 3, wherein the stator is stacked on one another in the insulating sheet like inductors.

5. The haptic touch sheet as set forth in claim 4, wherein the insulating sheet is configured of six layers.

6. The haptic touch sheet as set forth in claim 4, wherein the stator includes:
coils inserted in the insulating sheet and stacked on one another;
a via hole electrically connecting the coils;
a first lead-out via transmitting an electrical signal from the insulating sheet to the coils; and
a second lead-out via transmitting an electrical signal from the first lead-out via to the insulating sheet.

7. The haptic touch sheet as set forth in claim 4, wherein the haptic devices are arranged on the insulating sheet in a diamond pattern.

8. The haptic touch sheet as set forth in claim 2, wherein each of the piezo type haptic devices includes:
an upper electrode applying voltage when being touched;
a lower electrode driven by the voltage from the upper electrode; and
an actuator layer formed between the upper and lower electrodes,
wherein, in the actuator layer, an electrical field is formed by voltage from the upper electrode and mechanical and vertical deformation occurs.

9. A haptic touch module, comprising:
a window substrate;
a display unit facing the window substrate; and
a haptic touch sheet formed on one surface of the display unit and formed by integrating a plurality of haptic devices.

10. The haptic touch module as set forth in claim 9, wherein the plurality of haptic devices is employed as a vibration type or piezo type.

11. The haptic touch module as set forth in claim 10, wherein each of the vibration type haptic devices includes:
an upper case providing a space for rotation;
a rotation shaft vertically formed at the center of the upper case;
a rotator inserted into and supported rotatably by the rotation shaft; and
a stator disposed below the rotator and in the haptic touch sheet to be connected to an external power source.

12. The haptic touch module as set forth in claim 11, wherein the stator is stacked on one another in the haptic touch sheet like inductors.

13. The haptic touch module as set forth in claim 12, wherein the haptic devices are arranged on the haptic touch sheet in a diamond pattern.

14. The haptic touch module as set forth in claim 12, wherein the haptic touch sheet is configured of six layers.

15. The haptic touch module as set forth in claim 12, wherein the stator includes:
coils inserted in the haptic touch sheet and stacked on one another;
a via hole electrically connecting the coils;
a first lead-out via transmitting an electrical signal from the haptic touch sheet to the coils; and
a second lead-out via transmitting an electrical signal from the first lead-out via to the haptic touch sheet.

16. The haptic touch module as set forth in claim 15, wherein the first and second lead-out vias are made of Ag, Ag—Pd, Ni or Cu.

17. The haptic touch module as set forth in claim 10, wherein each of the piezo type haptic devices includes:
an upper electrode applying voltage when being touched;
a lower electrode driven by the voltage from the upper electrode; and
an actuator layer formed between the upper and lower electrodes,
wherein, in the actuator layer, an electrical field is formed by voltage from the upper electrode and mechanical and vertical deformation occurs.
